(19) United States
(12) Patent Application Publication
(10) Pub. No.: US 2006/0230903 A1
(43) Pub. Date: Oct. 19, 2006

(54) Polymer cutting apparatus and method

(76) Inventors: Jane P. Fisher, (US); George F. Fisher, (US); Marion G. Waggoner, (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/247,399

(22) Filed: Oct. 11, 2005

Related U.S. Application Data
(63) Continuation of application No. 10/458,907, filed on Jun. 11, 2003.
(63) Continuation-in-part of application No. 09/731,555, filed on Dec. 7, 2000, now abandoned.
(60) Provisional application No. 60/170,111, filed on Dec. 10, 1999.

(51) Int. Cl. B26D 1/12

(52) U.S. Cl. 83/663; 83/673; 83/855; 83/913

(57) ABSTRACT

A polymer cutter with a rotary cutting head in which the cutting edges are on the circumferential periphery of the head is described. The knife blades on the rotary head have a knife angle (as defined) of about 40° to about 60°. The apparatus is especially useful for cutting hard and/or brittle thermoplastics and may be used for preparing polymer granules or pellets.

### CROSS REFERENCE TO RELATED APPLICATION

This application is a continuation of Continuation-In-Part application Ser. No. 10/458,907, filed Jun. 11, 2003, and application Ser. No. 09/731,555, filed Dec. 7, 2000, which claimed the benefit of U.S. Provisional Application No. 60/170,111, filed Dec. 10, 1999.

### FIELD OF THE INVENTION

This invention concerns a rotary cutting head for cutting polymer, especially polymer strands and the like, and a process for cutting polymer using this head.

### TECHNICAL BACKGROUND

Polymers are abundant and important items of commerce, being useful in a myriad of applications. During handling, processing or reclamation of polymers it is often necessary to cut the solid (as opposed to molten) polymers into smaller pieces of various sizes and/or configurations. For instance, when thermoplastics are produced they are often cut into (uniform) pellets or granules of relatively small size so they can be easily fed to a forming machine such as an injection molding machine or an extruder. In this type of an operation it is important that the pellets produced be of reasonably uniform dimensions, and that relatively little or no other sizes such as dust or other off-size particles be produced

Cutters for polymers are available in many forms. In one common form a rotary head containing knives approximately parallel to the axis of rotation is used to cut polymer against a bed knife as the polymer is being fed into the cutter head. In these cutters the knives are such that they cut by combination of a slicing and a shearing action, with a narrow leading cutting edge cutting through the polymer. In such cutters the knife angle (see below) is typically 15-20°. This design allows for a large number of blades on a cutter head of a particular diameter, therefore increasing the cutting capacity (in weight of polymer cut per unit time) of the cutter. While cutters of this type have been popular for many years, they have certain drawbacks. Among these is cutter knife breakage and/or wear, especially when hard and/or abrasive polymers are being cut. Also particularly when hard and/or brittle polymers are being cut, cut quality is often not good, with large amounts of shattered pellets/fines, and/or long pellets and/or pellets with tails, being produced. Also when conventional cutters are being used the small knife angle makes the relatively thin knife edge prone to breakage and/or relatively fast wear. When breakage or excessive wear occurs, the cut quality is adversely affected, and the cutter must be shut down to resharpen or replace the worn or broken blades. This downtime is expensive in both actual maintenance costs and lost production time, and a polymer cutting apparatus which can cut at high speed with good cut quality, while at the same time requiring less downtime, would be advantageous.

### SUMMARY OF THE INVENTION

This invention involves a rotary cutter head having an axis of rotation, comprising, one or more knives, each knife having a cutting edge on a circumferential periphery of said rotary cutter head, each knife having a knife angle of about 40° to about 60°, and provided that no point on a cutting face of said knife is further from said axis of rotation of said rotary cutter head than said cutting edge.

Also described herein is a rotary cutter for cutting polymer, comprising, a bed knife, a rotary cutter head, and a means for advancing polymer into said rotary cutter head, and wherein said rotary cutter head has an axis of rotation and one or more knives, each knife having a cutting edge on a circumferential periphery of said rotary cutter head, each knife having a knife angle of about 40° to about 60°, and provided that no point on a cutting face of said knife is further from said axis of rotation of said rotary cutter head than said cutting edge.

This invention also concerns a process for cutting polymer with a rotary cutter, wherein the improvement comprises, using a rotary cutter head which has an axis of rotation and one or more knives, each knife having a cutting edge on a circumferential periphery of said rotary head, each knife having a knife angle of about 40° to about 60°, and provided that no point on a cutting face of said knife is further from said axis of rotation of said rotary head than said cutting edge.

### BRIEF DESCRIPTION OF THE DRAWINGS

FIG. 1 shows a cross section perpendicular to the axis of rotation of part of a typical rotary cutting head of this invention, together with a bed knife, a polymer strand, and a cut polymer particle.

FIG. 1A shows a magnified view of the tip of one of the knives (2) shown in FIG. 1 and illustrating that the cutting edge 20 may include a cylindrical land 100 having a radius r.

FIG. 2 shows a cross section perpendicular to the axis of rotation of a typical rotary cutter head of this invention, and in particular the cutter head used in the Example.

FIG. 3 schematically shows important elements of a rotary cutter head of this invention, as defined herein.

FIG. 4 shows the body (25) of the rotary cutter head used in the Example.

FIGS. 5A and 5B show one of the multiplicity of cap bars (6) used in the rotary cutter head of the Examples.

FIGS. 6A and 6B show one of the multiplicity of knife blade(2) used in the Example. These knives were made from tungsten carbide containing 12% nickel binder.

### DETAILS OF THE INVENTION

By a polymer herein is meant a polymer (or polymer blend) itself containing no additives, as well as polymers containing any additive or any combination of additives normally found in polymers. Such additives include pigments such as TiO₂, antioxidants, antiozonants, toughening agents, flame retardants, lubricants, dyes, antistatic agents, antistaining agents, and fillers and reinforcing agents such as talc, clay, carbon black, milled glass, glass fiber, carbon fiber, and aramid fiber. Preferred polymers are plastics (as opposed to elastomers), and thermoplastics are especially preferred. A more preferred polymer is a so-called thermotropic liquid crystalline polymer (LCP), or partially aromatic polyamide, and especially preferably the thermotropic LCP. These polymers tend to be hard and brittle, and shatter relatively easily. A thermotropic liquid crystalline polymer herein is given it conventional meaning, is an LCP by the TOT test described in U.S. Pat. No. 4,075,262, which is hereby included by reference.

The polymers being cut are preferably solid polymers. By that is meant that if crystalline, they are below their crystalline melting point, and if noncrystalline (i.e., glassy) they are below their glass transition temperatures.

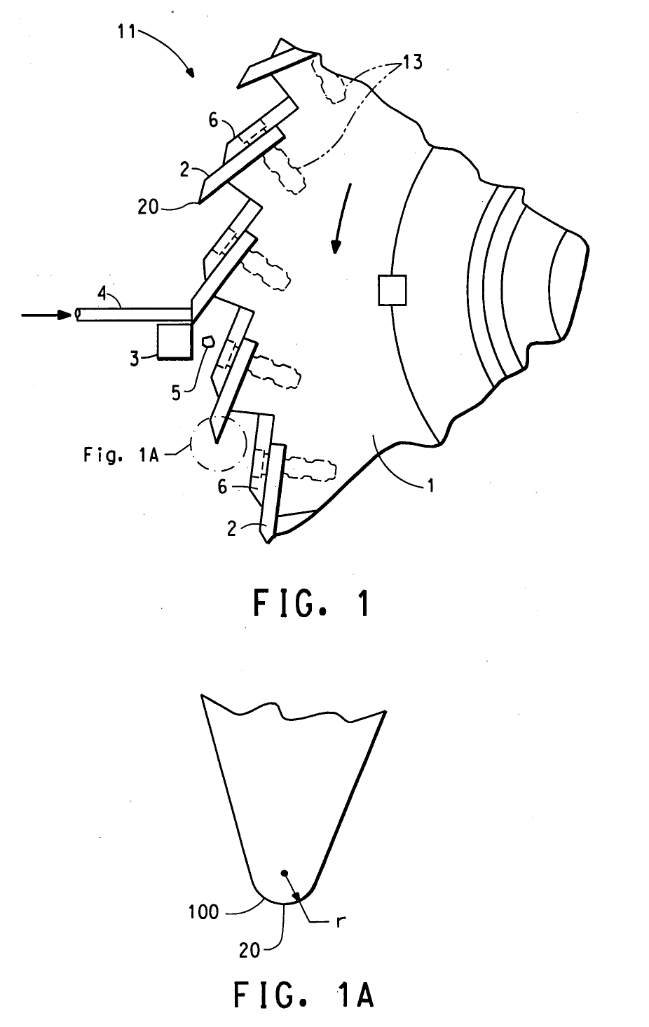

FIG. 1 is a general view of a break-away cross section of part of a rotary cutter head shown generally at 11, and other parts of a cutting apparatus, according to this invention. The parts of the rotary cutter head 11 shown are the rotary cutter head body 1 which rotates in the direction shown, several knives 2, and several cap bars 6 which hold the knives 2 in place on 1 (with bolts 13 shown in phantom outline). Also shown is a stationary bed knife 3, the mounting of which is not shown, a polymer strand 4 which is being fed in the direction shown, and a polymer granule 5 which has just been cut.

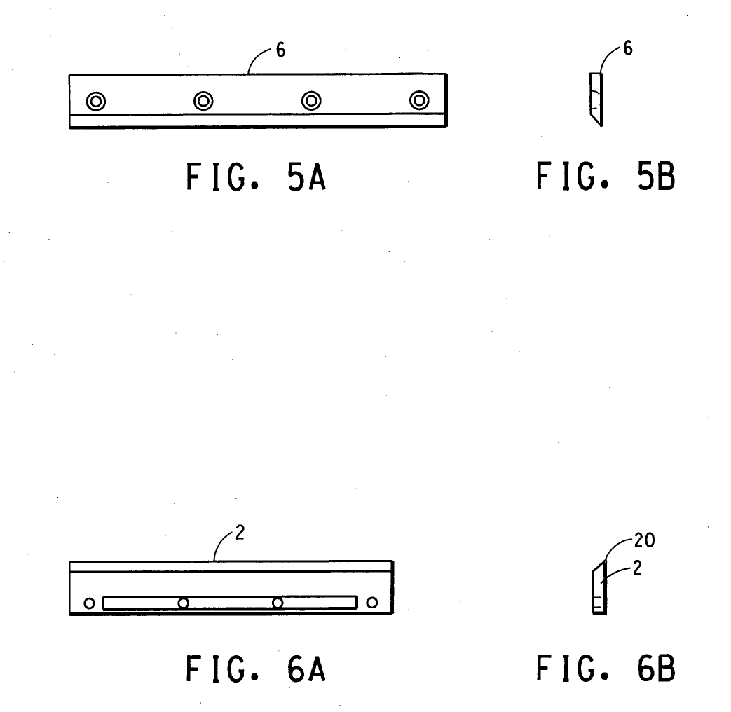

Respectively, FIGS. 5A and 5B illustrate the cap bars 6 and FIGS. 6A and 6B illustrate knife blades 2 used in accordance with the invention.

In the cutters described herein it is preferred that clearance between the cutting edge 20 of each knife 2 and the bed knife 3 be as small as practical. This tends to give the cleanest cut, and is usually about 0.025 to about 0.25 mm, preferably about 0.050 to about 0.12 mm.

Generally speaking, in such cutters the polymer 4 is advancing into the rotor knives 2 continuously, so after the cutting edge 20 of each knife 2 passes the bed knife 3, each cutter knife 2 is raked away from the edge of the bed knife. In other words, the point on the knife furthest away from the axis of rotation of the rotary cutter head is normally the cutting edge 20 of the knife 2, and all points on the knife cutting face are closer to the axis of rotation of the rotary cutter head 11 than the cutting edge 20. Furthermore, if applicable, the rotary cutter head 11 or its parts other than the knives are also preferably designed to allow the polymer to advance. Other designs will be obvious to the artisan to accomplish this.

The knives 20 may be separate parts which can be removed from the rotary cutter head 11 for sharpening or replacement, or other configurations are possible, which can be held in the rotary cutter head by bolts 13, caps 6, or wedges (no shown). Or the rotary cutter head may be a single piece of metal, with the knife edges hardened. This eliminates much machining. This is particularly useful where the knife edges don't chip or need sharpening very often.

Referring now to FIGS. 1 and 1A, it can be seen that each knife 2 includes a cutting edge 20. The cutting edge 20 may have a cylindrical land 100, having a radius r, formed thereon.

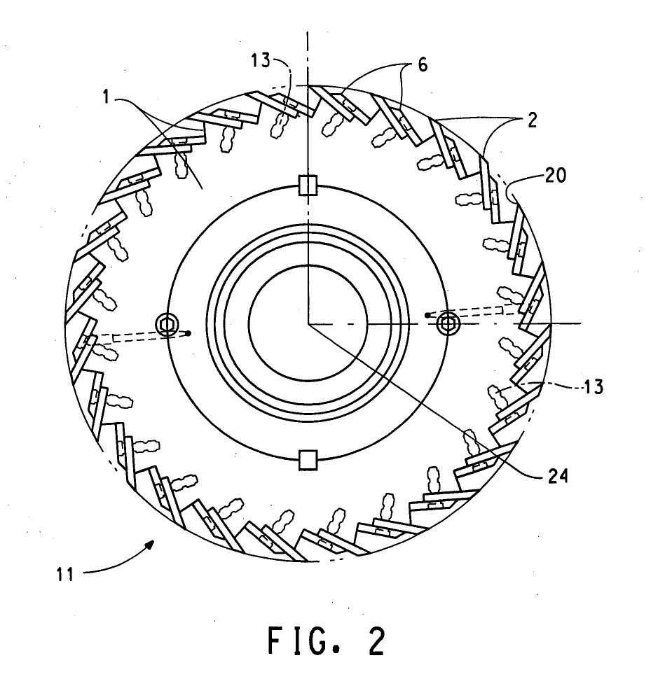

FIG. 2 shows a cross section perpendicular to the axis of rotation of a full rotary cutter head 11 according to this invention. This head has an axis of rotation 24, a body 1, a multiplicity of knives 2, held to the body with a multiplicity of cap bars 6, and a multiplicity of bolts, 13.

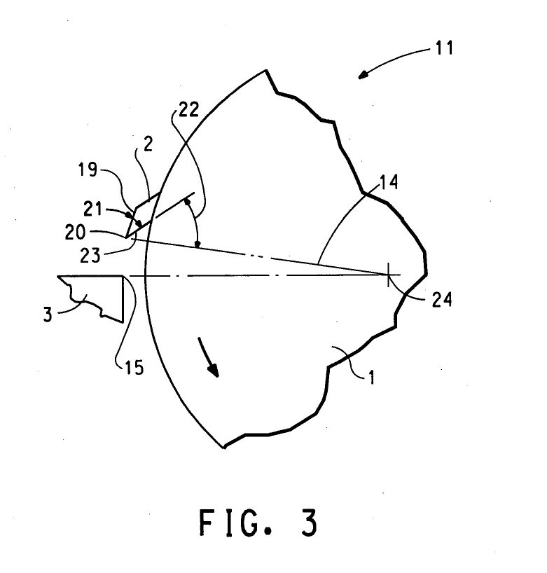

FIG. 3 is a breakaway schematic illustration showing important elements of the rotary cutter head of this invention 11 and their relationship to each other. Also included for completeness is a bed knife 3. The rotary head cutter 11 of FIG. 3 has an axis of rotation 24. For convenience in explanation a dashed line 14 (which is in fact a radius) has been drawn from axis of rotation 24 to the cutting edge 20 of the knife 2 which is mounted on body 1. Also included in FIG. 3 is a bed knife 3 having cutting edge 15. Protruding from the body 1 of the rotary cutter head 11 is knife 2 (of course more than one knife may be present), which has knife cutting face 19, and cutting edge 20. In addition the knife also has cutting edge angle 21, a knife forward surface 23, and knife angle 22. Knife angle 22 is measured from the radius 14 extended through cutting edge 20 to knife forward surface 23.

Normally the position of bed knife 3 and body 1 will be such that bed knife cutting edge 15 will be approximately parallel to the axis of rotation 24, and this position also will preferably minimize the clearance between bed kife cutting edge 15 and the cutting edge 20 of knife 2 when the rotary cutter head 11 is in operation.

The cutting edge angle of the knife 21 is the angle between the knife cutting face 19 and the knife forward surface 23. If one or both of cutting knife face 19 and 23 cutting knife forward surface is (are) curved, then the cutting angle 21 is taken as the angle between the tangent and the other arm of the angle or between the two tangents, (on one or both of cutting knife face 19 and cutting knife forward surface 23) at cutting edge 20. The maximum value of the cutting angle 21 is determined by knife angle 22 and the requirement that no part of the knife cutting face 19 be further from the axis of rotation 24 than knife cutting edge 20.

Angle 22 is the knife angle, the angle between a radius 14 from the axis of rotation 24, and the cutting knife forward surface 23, and is about 40° to about 60°, preferably about 45° to about 55°, and especially preferably about 47° to about 53°. In conventional cutters this angle is believed to be typically 15-20°.

No point on cutting face 19 should be further away from axis of rotation 24 than knife cutting edge 20, except when 20 may be worn (see below). This follows simply from the fact that one normally prefers to have knife cutting edge 20 as close to the bed knife cutting edge 15 as is practical while polymer 4 is being cut. If any part of cutting face 19 is further from the axis of rotation 24 than knife cutting edge 20, one simply will not be able to place 20 as close to bed knife cutting edge 15 as is preferred, without having the cutting face 19 strike bed knife cutting edge 15 when the rotary cutter head 11 is rotating. Preferably cutting face 19 should be raked back sufficiently to allow the polymer to advance after the knife cutting edge 20 has passed the cutting edge 15 of the bede knife 3, so that the next pellet may be cut by the succeeding knife. Thus the total of the cutting angle 21 and knife angle 22 in degrees will normally be less than 90°. Of course as knife cutting edge 20 suffers some wear from cutting polymer, a small portion of the cutting face 19 immediately adjacent to cutting edge 20 may be further from the axis of rotation 24 than the actual edge of 20. This is permissible, but of course when cutting edge 20 becomes badly worn it will preferably be sharpened to maintain a good polymer cut quality.

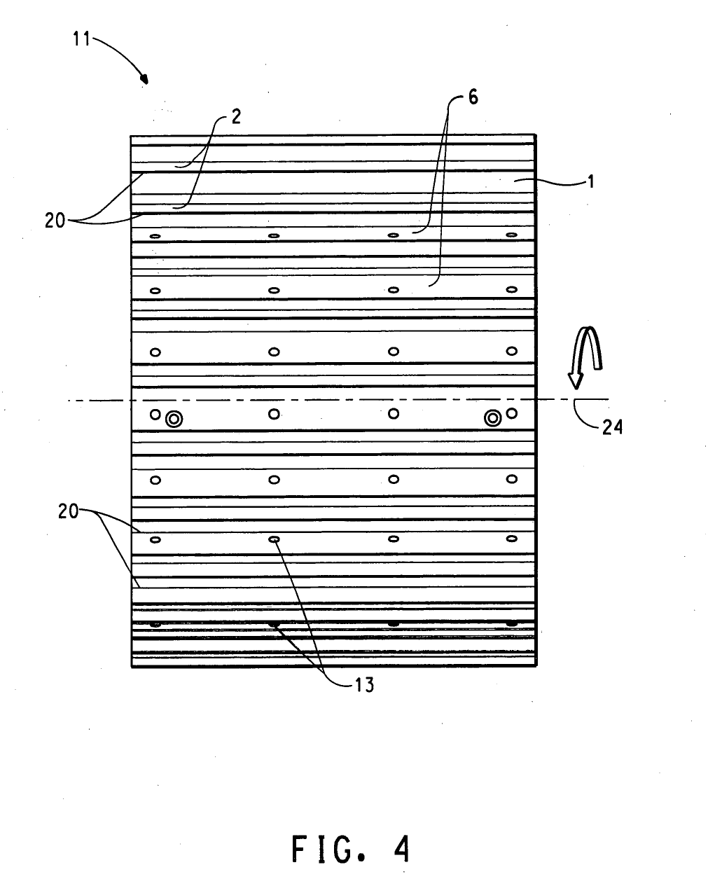

It is preferred, although not necessary, that some, and more preferably all, of the knives 2 run the full length of the body 1. Provision for this is shown in FIG. 4.

Referring now to FIGS. 4, it can be seen that across the length of the body 1 (perpendicular to the cross section shown in FIG. 2), 20 may be parallel to 13, or may be helically disposed (not shown) to the axis of rotation 24. Therefore essentially the entire length of knife cutting edges 20 will be at a constant distance from the axis of rotation. A preferred helical angle is about 0° to about 3° from the axis of rotation 24. When the body 1 is quite long, and for instance may be cutting many strands of polymer, the overall strain on any knife is lessened if that knife contacts the polymer strands in sequence, as it would do if the knife blade 20 was helically disposed about the axis of rotation 24.

As mentioned above, the more knife blades 2 on the cutter head, generally the larger the amount of polymer that can be cut (from strands to pellets for instance) per unit time. Thus at a given cutter head speed (rpm), the strand feed rate may be varied to obtain a given length of cut. If the number of knife blades 2 on the cutter head 11 is decreased, the feed rate of the polymer strand must be decreased and/or the speed of the cutter head increased to maintain the cut pellet size. Decreasing pellet production rate usually increases cost, so is not desirable. While increasing cutter head speed may be done there is usually a practical upper limit because of mechanical considerations. From geometrical considerations, at larger knife angles, fewer and fewer knife blades 2 may be on a cutter head 11 of a given diameter. While it may be desirable from a purely cut quality and downtime (less blade wear) perspective to have as large a knife angle as possible, the optimum knife angle will be a compromise between cut quality and/or downtime, and the productivity of the cutter head 11.

This invention also includes an apparatus for cutting polymers which includes the rotary cutter head 11 described above, a bed knife 3, and a means for advancing polymer into the rotary cutter head. The bed knife 3 is a usually stationary item that is placed so that clearance between the knives 2 of the rotary cutter head 11 pass as close to the bed knife 3 as reasonably possible while the rotary cutter head 11 is rotating. The “knife edge” of the bed knife 15 will usually have an angle of about 90°, and serves to keep the polymer from bending or otherwise moving as the knives 2 strike the polymer strand 4. Most commonly, the polymer strand 4 is fed over a surface of the bed knife into the rotary cutter head 11, as shown in FIG. 1.

The polymer strand 4 is usually advanced continuously as shown in FIG. 1, respectively, into the path of the knives 2 of the rotary cutter head. This requires a means for advancing the polymer. The cutter apparatus may be disposed so that the polymer strand 4 may “fall” into the rotary cutter head 11 by gravity. More commonly though the polymer strand 4 is fed by means of one or more pairs of feed rolls or a pair of feed conveyors (not shown). By feed rolls is meant a pair of rolls having a nip between them. Polymer is fed into the nip and the rolls are driven to move the polymer through the nip and into the rotary cutter head 11. A feed conveyor is similar, being a conveyor-like apparatus with two conveyor belts with the polymer being driven between the belts. The polymer may also be fed by being extruded from a die, the movement through and out of the die being the feed mechanism to the rotary cutter head. Other methods of feeding are known.

Inherent in the above discussion is a description of a process for cutting polymer using the rotary cutter head described herein. Many different shapes of polymer may be cut, such as sheets, strands, ribbons and tubes, especially thick-walled tubes. If the polymer to be cut is too thin, such as a small diameter fiber or a thin film the polymer may bend and may or may not be cut. It is preferred that the smallest cross sectional dimension of the polymer to be cut is about 1 mm or more, preferably about 2 mm or more. The maximum dimension will depend on the polymer being cut as well as the power of the cutter apparatus and the mechanical stress the cutting apparatus can endure.

One preferred form to be cut is one or more polymer strands. By a strand is meant a rod-like essentially continuous length of polymer whose largest cross sectional dimension is no more than 6 times, preferably no more than 3 times, and more preferably no more than 2 times greater than its smallest cross sectional dimension. A preferred cross section for a strand is approximately circular or square, with circular being especially preferred. It is preferred that the largest cross sectional dimension of the strand be about 1 to about 8 mm, preferably about 2 mm to about 4 mm. Cutting of strands into relatively short pieces, about 1 to about 8 mm long, or expressed another way the length to diameter ratio of the pellet is about 1, gives an especially useful form of polymer usually called pellets or granules. This is the most common form of solid polymer which is fed to injection molding machines, extruders, and the like.

Preferably the cutting edge 20 of the knife blade 2 is not ground as thin as possible, since this results in a weak cutting edge (because of the thin metal) which is prone to chip. Rather it is preferred that the blade edge be cylindrically ground. By this is meant that the cutting edge of the blade is ground in a generally circular (arc) configuration (defining a cylindrical land 100) with a given radius r (see FIG. 1A). Preferably the radius r, is about 0.10 mm to about 1.3 mm, more preferably about 0.25 mm to about 1.0 mm, and especially preferably about 0.35 mm to about 0.80 mm.

The rotary cutter 11 described herein gives cut polymer, especially pellets, and particularly with hard/brittle polymers which are often of a superior quality to conventional cutter, especially in regard to improving pellet uniformity and reducing dust and fines. In addition, the knife blade 2 often last longer than in a conventional cutter by reducing chipping and wear at the knife cutting edge 20.

### EXAMPLE

A cutter in accordance with our invention was used to cut circular cross section polymer strands using the cutter head of our invention. The cutter and various parts with their dimensions that was used is shown in FIGS. 2, and 4-6 (the cutter head was affixed to the rest of the cutter and rotated by a shaft passing though the head). The diameter of the strands entering the cutter was about 2.3 mm, and the length produced was also about 2.3 mm. The strands were melt extruded through die holes 4.0 mm in diameter and the strands while molten were drawn down to about 2.3 mm in diameter by the feed mechanism of the cutter. The strands were solid by the time they actually reached the cutter feed mechanism.

Over a period of slightly over 3 months a total of about 301,000 kg of various liquid crystalline polymers (LCPs) were passed through this cutter (in campaigns, not continuously), yielding about 277,000 kg of good quality pellets. Most of the LCPs has 30-40% by weight of glass fiber filler in them, as well as other materials such as carbon black or TiO₂. During this time period the bed knife was flipped or changed several times because of poor cut quality, and the rotor blades exhibited relatively little wear. However about 90% of the way (by weight) through this test, the left edge of the rotor (blades) apparently contacted the bed knife, and some chipping occurred there.

Compared to a cutter of the prior art, the knives were not dulled as quickly on this cutter, and the quality of the pellets cut was improved, especially in respect to the shape of the pellets themselves and elimination of long pellets.

While this invention has been described with respect to what is at present considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent formulations and functions.

1-3. (canceled)

4. A rotary cutter head having an axis of rotation, comprising, one or more knives, each knife having a cutting edge on a circumferential periphery of said rotary cutter head, each knife having a knife angle of about 40° to about 60°, and provided that no point on a cutting face of said knife is further from said axis of rotation of said rotary cutter head than said cutting edge.

5. The rotary cutter head as recited in claim 4 wherein said cutting edge includes a cylindrical land having a radius of about 0.10 mm to 1.3 mm.

6. A rotary cutter for cutting polymer, comprising, a bed knife, a rotary cutter head, and a means for advancing polymer into said rotary cutter head, and wherein said rotary cutter head has an axis of rotation and one or more knives, each knife having a cutting edge on a circumferential periphery of said rotary cutter head, each knife having a knife angle of about 40° to about 60°, and provided that no point on a cutting face of said knife is further from said axis of rotation of said rotary cutter head than said cutting edge.

7. The rotary cutter as recited in claim 6 wherein said cutting edge includes a cylindrical land having a radius of about 0.10 mm to 1.3 mm.

8. A process for cutting polymer with a rotary cutter, wherein the improvement comprises, using a rotary cutter head which has an axis of rotation and one or more knives, each knife having a cutting edge on a circumferential periphery of said rotary head, each knife having a knife angle of about 40° to about 60°, and provided that no point on a cutting face of said knife is further from said axis of rotation of said rotary head than said cutting edge.

9. The process as recited in claim 8 wherein said cutting edge includes a cylindrical land having a radius of about 0.10 mm to 1.3 mm.
